(19) United States
(12) Patent Application Publication
(10) Pub. No.: US 2007/0250328 A1
(43) Pub. Date: Oct. 25, 2007

(54) Geneticically engineered business and management structure

(76) Inventors: Randy A. Dingus, King George, VA (US); Craig Allan Mosser, Dale City, VA (US)

Correspondence Address: WILLIAM WIRT BROCK, IV, 1807 AVON ROAD, ROANOKE, VA, 24015, US

(21) Appl. No.: 11/391,428

(22) Filed: Mar. 29, 2006

(51) Int. Cl. G06Q 10/00; G06Q 30/00

(52) U.S. Cl. 705/1

(57) ABSTRACT

This invention relates to methods of doing business whereby subordinate business entities are structured under a parent controlling entity. Subordinate entities are capable of genetically propagating; a subordinate corporate entity and its propagates is termed a pod. A top-down management system is enacted, through feed-back loops from the genetic propagates of the subordinate entity. Through this feed-back loop, the entire structure of the parent business entity and its subordinate pod changes simultaneously in response to changes in business environment, sales figures, or other constraints selected for measurement. Subordinate corporate entities may be entirely different businesses as the parent corporate entity. The parent corporate entity always acts as manager, through an operating agreement, under which the subordinate corporate entities are organized. Subordinate corporate entities are always separate corporations, organized with separate corporate charters from the parent corporate entity.

### BACKGROUND OF THE INVENTION

1. Field of the Invention

By using computer networks such as the Internet, businesses and individuals are able to deliver audio/visual information in the form of websites to consumers and other users. Websites may be built and customized to the individual needs of the creator. They can be quite intricate and may require hundreds of man hours to develop. Businesses and individuals often incur great cost in this process by spending capital on the development and maintenance of their websites.

Often large companies have secondary entities such as divisions, subsidiaries, or franchises that desire their own websites to convey independent information. It is occasionally necessary for the secondary entity's website to maintain a similar appearance to the parent company's website while displaying their individual expertise. Independently creating each of these sites often means expensive development costs for the parent company. This can be especially difficult if the secondary entity is displaying information in a language other than English or if it conveys different user options.

The websites may contain text, graphics, images, sound, video, or other user interface options and are generally created in a standard hypertext document description language known as the Hypertext Markup Language (HTML). The HTML format allows a website developer to specify the location and presentation of the user interface options. In addition, the HTML format allows a website to contain links, such as the hypertext links described above, to other websites or servers on the internet. Simply by selecting a link as user can be transferred to the new website whose server may be located in a different geographic location than the original website.

Embodiments of the present invention include various steps which will be described below. The steps may be embodied in machine executable instructions. The instructions can be used to cause a general purpose or special purpose processor to perform certain steps. Alternatively, these steps may be performed by specific hardware components that contain hardwires logic for performing the steps. A mixture of programmed computer components and custom hardware components is also contemplated.

Elements of the present invention may also be provided as a machine-readable medium for storing the machine executable instructions. The class of machine readable media may include but is not limited to floppy diskettes, optical disks, CD-ROMs, magneto-opticaldisks, ROMs, RAMs, EPROMs, EEPROMS, magnet or optical cards, propagation media or other type of media/machine-readable medium suitable for storing electronic instructions. For example the present invention may be downloaded as a computer program which may be transferred from a remote computer (e.g., a server) to a requesting computer (e.g., client) by way of digital signals embodied in a carrier wave or other propagation medium via a communication link (e.g. a modem or network connection). Although this represents an improvement in computer oriented business, the application remains limited and the solution has not been applied broadly to top down business management.

It is expressly understood, however, that the instant invention is not limited to web-based internet business practices. In the broadest sense, which is fully contemplated in the practice of the invention, a propagation process is applied to virtually any product or service based corporation. As used herein, the term “corporate entity” includes any business or municipal establishment, such as businesses that provide products, or services, including close-held corporations, limited liability corporations, publicly traded stock corporations, or government entities.

2. Description of the Related Art

Top-down business methods are known in the prior art. Many types of businesses, including subsidiaries, chains and franchises, utilize a top-down management system. Decisions are made by managing officials, often without feedback from subordinate entities. Such methods of doing business are unable to adequately respond to variable market conditions and current trends because they are unable to quickly process and respond to business variables, such as: daily, seasonal and annual changes in sales figures; variations in overhead; and other costs per goods sold.

There have been many variations made to the above noted business method in an attempt to overcome the rigid structure of the top-down management system and its inability to rapidly adjust to current trends. Most notable of these variations is the traditional corporate structure, in which management is responsive to the decisions of stockholders; however, stockholders cannot quickly convene without following corporate bylaws and state corporate regulations. Furthermore, in large corporations, quickly convening the stockholders is not feasible because of the sheer numbers of stockholders. Change of management and other fundamental decision making therefore continues to respond slowly to outside stimuli despite the control checks inherent in the corporate environment. As a result, changes in business practices cannot evolve quick enough to accommodate the rapid changes experienced in the fluid business environment of the 21^{st} Century.

Other attempts have been made to improve top-down management through replication of the subordinate business entities. See for instance U.S. Pat. No. 6,873,957, issued to Chen et al., the entire specification of which is incorporated herein by reference. A computer-implemented method is disclosed for replicating Websites in a digital network. The method comprises converting a website into a Super Site, wherein the Super Site may be replicated. One or more Sub Sites is generated from the Super Site. The behaviors of the Sub Sites are configured to match desired population segment characteristics. However, until now, no such method has been utilized to control general business methods, i.e. the method of Chen et al. was limited to internet business development. The utility of the genetically propagated business model has been heretofore unrecognized.

### BRIEF SUMMARY OF THE INVENTION

Genesis Business Systems (GBS) is a corporate genetic engineering philosophy. The premise of GBS is the forming of a relationship, whether it is an operating agreement or otherwise, between an existing and/or future corporation, partnership, limited liability corporation, or proprietorship. During the forming of this GBS relationship, the parent entity is given the ability to genetically code the subordinate entity to strategically meet the challenges of any structured or unstructured arenas to gain a competitive advantage therein.

As defined herein, the GBS system is intended to be used with any existing or future business entity. The invention is not limited to any particular type of business entity. GBS is broadly applicable to manufacturing, service or even governmental or educational entities.

Feedback from the subordinate to the parent is generated through a network which allows constant communication. Various algorithms are utilized within the parent entity to manipulate the feedback generated by the subordinate in order to gain a competitive advantage. Although the parent entity ultimately can be given the final decision to override the subordinate entities, it is contemplated that a simple majority of subordinate entities could be given the authority to alter the structure of the parent, and thereby change themselves through top-down, genetic propagation. All of the subordinates would therefore respond to the decisions of the majority. It is to be understood however, that the GBS system is not limited to any particular algorithm, but rather any generic algorithm designed to manipulate the subordinate entity's feedback.

Through the genetic replication process, the subordinate entities are maintained as propagates throughout the network of entities, of a particular type of subordinate entity. While the subordinate entities may be consistent across the network of a particular type of subordinates, the bottom-up feedback mechanism allows the parent entity to rapidly respond to market conditions. The GBS system protects the network of entities from irregularities within a few subordinates by requiring a majority of the subordinates to provide the necessary feedback while simultaneously allowing rapid change unlike in a traditional franchise situation.

### DETAILED DESCRIPTION OF THE INVENTION

GBS is a management system, utilizing feedback mechanisms transmitted from subordinate entities to the parent entity. Initially a parent entity is formed and the parent genetic code is propagated throughout the subordinate entities. That is, the subordinate entities are propagates of the parent entity. Unlike traditional franchise schemes, however, the parent entity in GBS is responsive to feedback from the subordinate entities.

Because the parent entity can be any type of private or governmental organization, the genetic code can represent a myriad of business plans or agreements. For instance, the genetic code of the parent could be a simple operating agreement between the parent and subordinate entities. Part of this operating agreement would be the ability for the subordinate to propagate itself further, thereby creating more subordinate entities much as when cells divide. Of course, the operating agreement formed between the parent and the initial subordinate entity would also be propagated because the operating agreement is the genetic code.

Unlike the traditional franchise, top-down management systems, the GBS utilizes feedback mechanisms from the subordinate entities. For instance, a computer network can be established where through a common internet protocol address all the subordinates supply information to the parent entity regarding sales, inventory, market conditions, or other indicators designated by the parent. In this manner, when market conditions suddenly change, the subordinates are able to quickly inform the parent entity through the network and the parent entity can then establish new policies in all subordinates simultaneously. Through this method, the subordinates uniformly respond to fluctuations in market conditions.

In practice, a parent corporate entity is designated or otherwise established. Subordinate corporate entities are designated or otherwise established by genetic replication from the parent corporate entity. The subordinate corporate entities are then managed from the common corporate parent entity. Business practices are established by the parent corporate entity and the subordinate corporate entities are subjected to these business practices in order to provide desired produce or service characteristics tailored to the particular customer population. Feedback mechanisms are established whereby changes in customer population or other parameters affecting the customer preferences are utilized whereby the subordinate corporate entities feed this information to the parent corporate entity, enabling rapid modification of the genetic corporate structure. In this way, the entire corporate structure is readily modified from a top down replication process, even though the data is supplied from a bottom up scheme.

It is also contemplated that a pure management entity interposes between the parent corporate entity and the subordinate entities. In this scheme, the parent corporate entity has delegated the management process of all the subordinate corporate entities to the management entity, even though the management entity remains subordinate to the final decisions of the parent corporate entity.

Characteristics which are capable of modification through the network include, but are not limited to operating hours, product selection, inventory and service selection. For governmental units, such parameters as operating policy, etc. are capable of modification and replication through utilization of the system. Feedback from the subordinate corporate entities is capable of altering the cloned subordinate corporate entities through conformation according to the feedback alteration of the parent corporate entity.

Of course, a computer can be utilized to interrelate the parent corporate entities and the subordinate corporate entities, thereby maintaining replication of the parent corporate entity by the subordinate corporate entities. A computer network is established whereby feedback data is received by computers from the subordinate corporate entities, by a central computer located at the parent corporate entity. In this manner, data received from the subordinate corporate entities can be evaluated, and the parent corporate policy modified accordingly. Immediate replication of the subordinate corporate entities, according to changes in the parent corporate entity, is enabled by computer communication to the subordinate corporate entity computers through the computer network.

New subordinate corporate entities may be purchased, at a predetermined rate. The purchase rate is another parameter that can be modified by feedback from the network. New subordinate corporate entities are accepted by feedback from all existing subordinate corporate entities, of course subject to final approval by the parent corporate entity. Any existing subordinate corporate entity may be modified or replaced through subordinate corporate entity feedback, contingent on parent corporate entity approval.

Subordinate corporate entities are extinguished through relinquishment of subordinate corporate entity shares or stock, when the subordinate entities are actual stock corporations, as opposed to governmental units. Subordinate corporate entity stocks or shares are purchased by remaining subordinate corporate entities at their initial purchase price, or some price determined by feedback from the subordinate entities, contingent upon approval by the parent corporate entity.

An access address, as conventional in computer networks, is available to new genetically cloned subordinate corporate entities only through discretion of existing subordinate corporate entities and final parent corporate entity approval.

It is also contemplated within the scope of the invention that individual subordinate corporate entities that are organized under the parent corporate entity do not necessarily have to be exact genetic replications of the parent corporate entity. In fact, the subordinate corporate entities do not have to even be in the same business. For instance, subordinate corporate entities can be service organizations, such as barber shops, and the parent corporate entity could be predominately a product oriented business, such as the manufacture and sale of barber implements. In this mode of the invention, the parent corporate entity acts as a management entity that manages the subordinate corporate entity. Subordinate corporate entities themselves can diverse into different products or services by the same process, i.e. they can become management entities for diverse subordinate corporate entities, always remaining subordinate to the original parent corporate entity.

It is paramount to understand that the subordinate corporate entities are organized independently of the parent corporate entities. However, under an operating agreement negotiated with the subordinate corporate entities, the parent corporate entity manages the subordinate corporate entities, either directly or through an interposed management entity. The subordinate corporate entities that are independent entities, but managed by the parent corporate entity, are free to propagate; the propagated corporate entities are organized under the same corporate structure as the original subordinate corporate entity. For instance, a new subordinate corporate entity organizes, under an operating agreement with the parent corporate entity, as a new limited liability corporation. The new subordinate corporate entity then propagates itself, and the new subordinate corporate entities are organized under the same limited liability corporate charter as the original subordinate corporate entity. Such a new branch of subordinate corporate entities is termed a “pod”. Again, individual limited liability corporations do not have to be in the same business. But they do have a common management, the parent corporate entity.

The subordinate corporate entities are individually owned. Under an operating agreement, they can purchase or other license a business name from the parent corporate entity. They could lease space in a building owned by the parent corporate entity. Because the subordinate corporate entities maintain independent ownership, they are neither employees nor subcontractors of the parent corporate entities. In this manner, the individual subordinate corporate entities do not share liability with other subordinate corporate entities not of the same pod, nor do they share liability with the parent corporate entity. Likewise, and of paramount importance, the subordinate corporate entities do not share tax liability with the parent corporate entities.

A wagon wheel is a good analogy for visualizing the parent corporate entity and the subordinate corporate entities. The parent corporate entity is found in the center of the wheel. Subordinate corporate entities are like the spokes, radiating from the center. Each subordinate corporate entity is an individual spoke, with individual corporate charters. All the spokes are managed centrally from the center, the parent corporate charter. Each spoke could have several subordinate corporate entities organized under the same charter; this is termed a “pod”. Pods are collective subordinate corporate entities, organized under a common corporate charter. Pods are always managed by the parent corporate entity, but remain independent corporations. They are structured in this manner by the operating agreement, in the form of a contract, or governmental charter. Of course, one of the greatest advantages of this radiating structure is that the parent corporate entity is in a position to enable subordinate corporate entities to support each other, in a circumferential relationship. Two subordinate corporate entities on separate radial spokes can thus support each other, and both support the parent corporate entity in the center, in a triangle like relationship. Such corporate structure is stronger than the simple top-down structure of conventional franchise organization, much as a triangle is the strong building block of structural engineering.

An advantage of the individually chartered corporate subordinate entities should be immediately apparent. Besides the separate tax consequences, i.e. the subordinate corporate entities are neither employees nor subcontractors of the parent corporation, the subordinate corporate entities are not liable to each other for business losses. In that manner, the central parent corporate entity can organize circumferential support among the pods, or the central parent corporation can shield itself from losses by the individual pods. This gives the entire structure of central parent management and individually chartered pods the greatest flexibility to adjust to changing market conditions, as well as the greatest protection from liability and individual pod losses and tax liability.

Profits are shared among subordinate corporate entities and the parent corporate entity according to pre-established algorithms. A computer is usable for these algorithms, as well as any feedback or algorithm within the scope of the invention. The parent corporate entity simply provides a template site used for genetic replication of subordinate corporate entities, regardless of the specific business or governmental operation. A computer is usable in all aspects of the invention and is expressly contemplated for inclusion.

Algorithms to evaluate feedback from the subordinates is essential to practice the instant invention. Special algorithms suitable for the particular business entities are established at the formation of the parent entity. In some instances, the algorithm may be as simple as the following: a majority of the subordinates is necessary to implement a change.

Another type of scheme could involve comparison to market trends. In such a scheme, feedback would comprise the difference between market trends and the current set point. The parent entity could then establish a new set point which would be genetically propagated throughout the network in response to the change in market conditions. The set point change could utilize a proportional, derivative or integral type response, or could utilize a combination of these three mechanisms as is well known in the art of automatic control.

A risk assessment of changes in set points is easily integrated into the GBS system. Conventional cost/benefit analysis by the parent can be quickly performed utilizing the feedback from the subordinates. For instance, the expected value of an alternative can be multiplied by the expected frequency of the alternative to quantify risk. Normal, overall expected values are established for comparison. More sophisticated risk analyses, for example, where the expected value and frequency of the catastrophic events are separately evaluated are within the scope of GBS feedback mechanisms.

Multi-objective, multi-variable risk analysis is suitable for use within the feedback systems of GBS. A zone of indifference is defined within which the competing interests of the multi-variables can exist. Then the parental optimal frontier can be established within the zone of indifference. Normal, overall expected values of risk are used in this initial analysis. Risk is then further defined by evaluating the catastrophic events separately so that the impact of the rare catastrophic event is not overshadowed by averaging the rare events in with the common events of the high frequency. In this manner, the parent can establish a new policy, i.e., new set points, with assurance that the subordinates have not overlooked any major considerations, thereby balancing the overall power of the network.

Algorithms are also pre-established for dissolution of subordinate entities. This is normally part of the parent entity organizational structure which is then coded into the genetically replicated subordinate entities. As an example, it may be required that new subordinates purchase stock in the parent entity. Upon dissolution, the dissolved subordinate's stock could be repurchased by the parent entity, utilizing a preestablished scheme for evaluation of the stock.

Likewise a feedback mechanism can be established such that certain conditions must be met before a new subordinate is allowed to be established. Risk analysis or other suitable numerical method of evaluation can be utilized before permission is given for further propagation.

While specific objects and features of the subject invention have been disclosed in full detail herein, it will be readily understood that the invention encompasses all modifications and enhancements within the scope and spirit of the following claims.

What is claimed is:

1. A method for use in genetically encoding corporate entities, whereby corporate entities are genetically engineered and propagated comprising:
designating a parent corporate entity, and establishing subordinate corporate entities, wherein the subordinate corporate entities are genetically propagated from the parent corporate entity;
generating a plurality of replicated subordinate corporate entities from the parent corporate entity, wherein the subordinate corporate entities are manageable from the common parent corporate entity; and
establishing business practices of the subordinate corporate entities to provide desired product or service characteristics tailored to the customer population.

2. The method of claim 1 wherein a computer is used to interrelate the parent corporate entity and the subordinate corporate entities, thereby maintaining propagated of the parent corporate entity by the subordinate corporate entities.

3. The method of claim 2 wherein a top-down management relationship is established between the parent corporate entity and the subordinate corporate entities.

4. The method of claim 2 wherein new subordinate corporate entities may be purchased, at a predetermined set fee.

5. The method of claim 2 wherein new subordinate corporate entities are accepted by feedback from all existing subordinate entities, and all final decisions are rejectable by the parent corporate entity.

6. The method of claim 2 wherein any existing subordinate corporate entity may be modified or replaced through subordinate corporate entity feedback, contingent of parent corporate entity approval.

7. The method of claim 2 wherein existing subordinate corporate entities are extinguished through operating agreement or other pre-established process.

8. The method of claim 7 wherein the subordinate corporate entity shares or stock are transferred to remaining subordinate corporate entities at their initial purchase price.

9. The method of claim 2 wherein access to the common address is available to new genetically coded subordinate corporate entities only through discretion of existing. subordinate corporate entities and final parent corporate entity approval.

10. The method of claim 2 wherein operating hours, product selection, inventory and service selection are determined by feedback from subordinate corporate entities through the common address.

11. The method of claim 10 wherein said feedback alters the parent corporate entity, and each genetically cloned subordinate corporate entity conforms according to the feedback alteration of the parent corporate entity.

12. The method of claim 2 wherein profits are shared among subordinate corporate entities and the parent corporate entity according to pre-established algorithms.

13. The method of claim 12 wherein the pre-established algorithms for sharing profits are operated using a computer.

14. The method of clam 2, wherein the parent corporate entity is a template site used for genetic propagation of a subordinate corporate entity.

15. The method of claim 2 wherein the subordinate corporate entities are organized as separate corporations, with separate corporate charters, under the parent corporate entity through an operating agreement, and managed by the parent corporate entity.

16. The method of claim 15 wherein pods of subordinate corporate entities are formed from an original subordinate corporate entity by replicating new subordinate corporate entities, and the new subordinate corporate entities are organized under the same corporate charter as the original subordinate corporate entity.

17. The method of claim 16 wherein the operating agreement under which the original subordinate corporate entity is organized, is replicated with the new subordinate corporate entities.

18. An integrated framework for analyzing and managing a collective of corporate entities, comprising:
a central parent corporate entity;
subordinate corporate entities organized radially around the central parent corporate entity, wherein each subordinate corporate entity is a separate corporate entity according to individual corporate charters for each subordinate corporate entity, and wherein each subordinate corporate entity is capable of genetic propagation;
an operating agreement under which each subordinate corporate entity and its propagates is established under the parent corporate entity;
relationships between the subordinate corporate entities and their genetic propagates, called pods, wherein the pods support each other and support the central parent corporate entity, through radial support for each pod to the central parent corporate entity, and circumferential support for the pods with other pods, whereby the collective of the central parent corporate entity and its pods is capable of modifying the network to adjust to future scenarios and changing to adjust to market variability.
